(19) United States
(12) Patent Application Publication
(10) Pub. No.: US 2025/0392373 A1
(43) Pub. Date: Dec. 25, 2025

(54) METHOD, NETWORK CONTROLLED REPEATER, AND ACCESS NETWORK NODE

(71) Applicant: NEC Corporation, Minato-ku, Tokyo (JP)

(72) Inventors: Yuhua CHEN, Tokyo (JP); Satoaki HAYASHI, Tokyo (JP)

(73) Assignee: NEC Corporation, Minato-ku, Tokyo (JP)

(21) Appl. No.: 18/879,423

(22) PCT Filed: Jul. 26, 2023
(86) PCT No.: PCT/JP2023/027365

§ 371 Date: Dec. 27, 2024

(30) Foreign Application Priority Data
Aug. 9, 2022 (GB) 2211653.7

(51) Int. Cl. H04B 7/155; H04W 76/27

(52) U.S. Cl. CPC H04B 7/15507; H04W 76/27

(57) ABSTRACT

The present disclosure relates to a method performed by a network controlled repeater, NCR, the method comprising: receiving, from an access network node, an NCR support indication that indicates whether a function of the NCR is supported by the access network node; and transmitting, to the access network node, when the NCR support indication indicates that the function of the NCR is supported by the access network node, an NCR device indication that indicates that the NCR is an NCR device.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to improvements related to network controlled repeaters (NCR) and beamformed signals.

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. End-user communication devices are commonly referred to as User Equipment (UE) which may be operated by a human or comprise automated devices. Such communication devices might be, for example, mobile communication devices such as mobile telephones, smartphones, smart watches, personal digital assistants, laptop/tablet computers, web browsers, e-book readers, connected vehicles, and/or the like. Such mobile (or even generally stationary) devices are typically operated by a user (and hence they are often collectively referred to as user equipment, ‘UE’) although it is also possible to connect Internet of Things (IoT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC, IoT/Industrial IoT (IIoT) communications, vehicular communications and autonomous cars, high resolution video streaming, smart city services, and/or the like. 3GPP intends to support 5G by way of the so-called 3GPP Next Generation (NextGen) radio access network (RAN)/radio access technology (RAT) and the 3GPP NextGen core (NGC) network. Various details of 5G networks are described in, for example, NPL 1.

In a communication network a UE may fall outside of a transmission range of a base station. However, a repeater may be provided that receives transmissions from the base station and retransmits the received signals to effectively extend the range of the base station. The UE is therefore able to communicate with the base station via the repeater. The repeater provides a flexible alternative to extending the coverage of the network without deploying additional regular full-stack cells. The repeater may be referred to as a radio frequency repeater (RF repeater). A simple repeater may receive a signal from the base station and simply broadcast the received signal omnidirectionally. In other words, a RF repeater may simply amplify and forward signals it receives from the base station, so as to provide an area of extended coverage. Whilst RF repeaters provide a relatively cost-effective method of extending network coverage, simple amplification and omnidirectional forwarding may not be suitable when the original transmission from the base station is a beamformed transmission. A repeater may be required by the network to transmit the received signal as a beam in a particular direction at a particular time, and may need to be configured to receive a signal from a UE from a particular direction at a particular time and frequency on an access link. In order to inform the repeater of configuration information for transmitting and receiving beamformed signals, the repeater may receive corresponding control information from the base station. Such repeaters may be referred to as ‘network controlled repeaters’ (NCR), and the control information received from the base station may be referred to as ‘side control information’.

An NCR 9 includes a NCR-Mobile termination (NCR-MT). The NCR-MT is an entity that communicates with a gNB via a control link (C-link), enabling the exchange of the side control information. The C-link is based on the new radio (NR) Uu interface.

Authentication methods for a UE in a 5G network are described, for example, in NPL 2, and further procedures are described in NPL 3.

### CITATION LIST

### Non Patent Literature

NPL 1: ‘NGMN 5G White Paper’ V1.0 by the Next Generation Mobile Networks (NGMN) Alliance, <https://www.ngmn.org/5g-white-paper.html>
NPL 2: 3GPP TS 33.501 v17.6.0
NPL 3: 3GPP TS 23.502 V17.5.0
NPL 4: 3GPP TS 38.331 v17.1.0
NPL 5: 3GPP TS 38.300 V16.7.0
NPL 6: 3GPP TS 37.340 V16.7.0
NPL 7: 3GPP TS 22.368 V13.1.0

### SUMMARY OF INVENTION

### Technical Problem

However, there is a desire for new higher layer procedures for communication between an NCR and an gNB, to facilitate integration of an NCR in the network. For example, there is a desire for improved identification and authorisation procedures for the NCR, improved information exchange between the gNB and the NCR-MT, and improved gNB broadcast signalling.

The present disclosure seeks to provide methods and associated apparatus that address or at least alleviate (at least some of) the above-described issues.

### Solution to Problem

In one aspect the disclosure provides a method performed by a network controlled repeater, NCR, the method comprising: receiving, from an access network node, an NCR support indication that indicates whether a function of the NCR is supported by the access network node; and transmitting, to the access network node, in a case where the NCR support indication indicates that the function of the NCR is supported by the access network node, an NCR device indication that indicates that the NCR is an NCR device.

The method may further comprise: transmitting, to the access network node, in a case where the NCR support indication indicates that the function of the NCR is supported by the access network node, a request to set up a radio resource control, RRC, connection; receiving, from the access network node, a response to the request to set up the RRC connection; and transmitting an RRC message to the access network node, wherein the RRC message includes the NCR device indication.

The method may further comprise: transmitting, to the access network node, an indication corresponding to radio capability information of the NCR; wherein the indication corresponding the radio capability information of the NCR may include the NCR device indication.

The NCR support indication may be received from the access network node as part of system information transmitted by the access network node.

The NCR support indication may be received from the access network node in system information block, SIB, information transmitted by the access network node.

The NCR support indication may be received from the access network node in SIB1; and when multiple public land mobile network, PLMN, are indicated in SIB, the NCR support indication is common to all of the indicated PLMN.

In one aspect the disclosure provides a method performed by a network controlled repeater, NCR, the method comprising: transmitting, to an access network node, forwarding capability information indicating a forwarding capability of the NCR.

The forwarding capability information may indicate a number of syncronisation signal blocks, SSBs, supported by the NCR.

The method may further comprise: receiving, from the access network node, forwarding control information for controlling forwarding by the NCR.

The forwarding control information may be received from the access network node in RRC signalling. The forwarding control information may be received from the access network node in an RRC reconfiguration message. The forwarding control information may be received from the access network node in an NCR setup message.

The method may further comprise: transmitting, to the access network node, an NCR setup complete message after receiving the NCR setup message; and activating forwarding between the NCR and a user equipment, UE, based on the forwarding control information received from the access network node.

The forwarding control information may comprise at least one of: a set of syncronisation signal blocks, SSBs, for use by the NCR to forward signals; timing information indicating a time at which the NCR is to forward a signal between the access network node and a user equipment, UE; frequency information indicating a frequency to be used for communication on an access link between the NCR and a UE, or a frequency to be used for communication between the NCR and the access network node; or beam information indicating a beam direction to be used for a transmission or reception between the NCR and the UE, or for a transmission between the NCR and the access network node.

The method may further comprise: receiving further forwarding control information from the access network node; and controlling forwarding between the NCR and a user equipment, UE, based on the further forwarding control information.

The further forwarding control information may be received from the access network node in a medium access control control-element, MAC CE.

In one aspect the disclosure provides a method performed by an access network node, the method comprising: transmitting, to a network controlled repeater, NCR, an NCR support indication that indicates whether a function of an NCR is supported by the access network node; and receiving, from the NCR, in a case where the NCR support indication indicates that the function of the NCR is supported by the access network node, an NCR device indication that indicates that the NCR is an NCR device.

The method may further comprise: receiving, from the NCR, when the NCR support indication indicates that the function of the NCR is supported by the access network node, a request to set up a radio resource control, RRC, connection; transmitting, to the NCR, a response to the request to set up the RRC connection; and receiving an RRC message from the NCR, wherein the RRC message includes the NCR device indication.

The method may further comprise transmitting, to a core network node for mobility management, after the access network node has received the RRC message from the NCR, and INITIAL UE MESSAGE comprising the NCR device indication.

The method may further comprise: receiving, from the NCR, an indication corresponding to radio capability information of the NCR; wherein the indication corresponding the radio capability information of the NCR includes the NCR device indication.

Transmitting the NCR support indication may comprise transmitting system information that includes the NCR support indication. Transmitting the NCR support indication may comprise transmitting system information block, SIB, information that includes the NCR support indication.

In one aspect the disclosure provides a method performed by an access network node, the method comprising: receiving, from a network controlled repeater, NCR, forwarding capability information indicating a forwarding capability of the NCR.

The forwarding capability information may indicate a number of syncronisation signal blocks, SSBs, supported by the NCR.

The method may further comprise: transmitting, to the NCR, after receiving the forwarding capability information, forwarding control information for controlling forwarding by the NCR.

Transmitting the forwarding control information may comprise transmitting RRC signalling including the forwarding control information. Transmitting the forwarding control information may comprise transmitting the forwarding control information in an RRC reconfiguration message. Transmitting the forwarding control information may comprise transmitting the forwarding control information in an NCR setup message.

The method may further comprise: receiving, from the NCR, an NCR setup complete message after transmitting the NCR setup message.

The forwarding control information may comprise at least one of: a set of syncronisation signal blocks, SSBs, for use by the NCR to forward signals; timing information indicating a time at which the NCR is to forward a signal between the access network node and a user equipment, UE; frequency information indicating a frequency to be used for communication on an access link between the NCR and a UE, or a frequency to be used for communication between the NCR and the access network node; or beam information indicating a beam direction to be used for a transmission between the NCR and the UE, or for a transmission between the NCR and the access network node.

The method may further comprise: transmitting further forwarding control information to the NCR; wherein the further forwarding control information is for control, by the NCR, of forwarding between the NCR and a user equipment.

In one aspect the disclosure provides a network controlled repeater, NCR, comprising: means for receiving, from an access network node, an NCR support indication that indicates whether a function of the NCR is supported by the access network node; and means for transmitting, to the access network node, in a case where the NCR support indication indicates that the function of the NCR is supported by the access network node, an NCR device indication that indicates that the NCR is an NCR device.

In one aspect the disclosure provides a network controlled repeater, NCR, comprising: means for transmitting, to an access network node, forwarding capability information indicating a forwarding capability of the NCR.

In one aspect the disclosure provides an access network node comprising: means for transmitting, to a network controlled repeater, NCR, an NCR support indication that indicates whether a function of an NCR is supported by the access network node; and means for receiving, from the NCR, in a case where the NCR support indication indicates that the function of the NCR is supported by the access network node, an NCR device indication that indicates that the NCR is an NCR device.

In one aspect the disclosure provides an access network node comprising: means for receiving, from a network controlled repeater, NCR, forwarding capability information indicating a forwarding capability of the NCR.

### BRIEF DESCRIPTION OF DRAWINGS

Example embodiments of the disclosure will now be described, by way of example, with reference to the accompanying drawings in which:

FIG. 1 illustrates schematically a mobile (cellular or wireless) telecommunication system to which example embodiments of the disclosure may be applied;

FIG. 2 shows a schematic diagram of a network-controlled repeater (NCR) arranged between a base station and a UE;

FIG. 3 is a schematic block diagram of a mobile device;

FIG. 4 is a schematic block diagram of a base station;

FIG. 5 shows a schematic block diagram of an NCR;

FIG. 6 shows an example of communication between the gNB and the UE via the NCR;

FIG. 7 shows a schematic flow diagram illustrating an NCR procedure;

FIG. 8 shows an NCR-MT initial access procedure;

FIG. 9 shows an NCR-Fwd setup procedure;

FIG. 10 shows an NCR forwarding procedure;

FIG. 11 shows a modified version of the NCR forwarding procedure;

FIG. 12 shows a first example of timing information;

FIG. 13 shows a second example of timing information; and

FIG. 14 shows a third example of timing information.

### DESCRIPTION OF EXAMPLE EMBODIMENTS

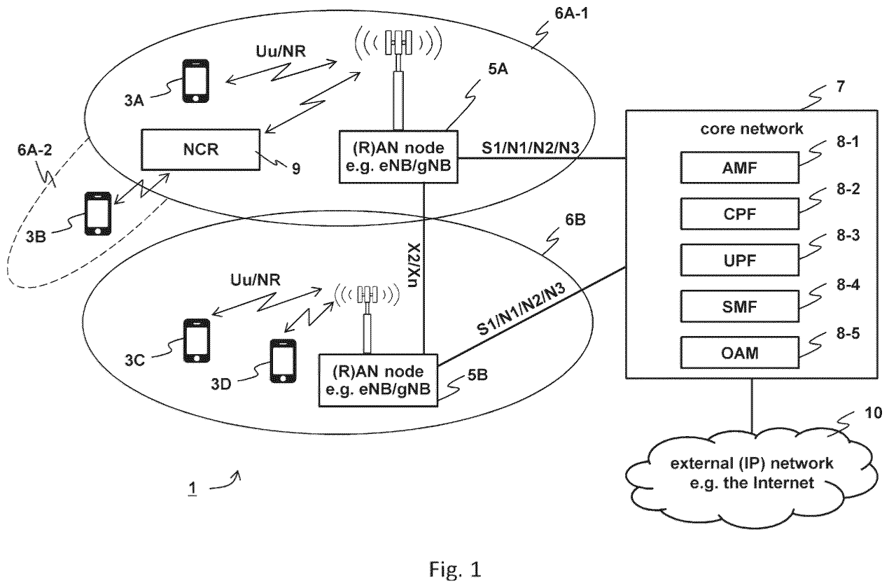

FIG. 1 illustrates schematically a mobile (cellular or wireless) telecommunication system 1 to which example embodiments of the disclosure may be applied.

In this system 1, users of mobile devices 3 (UEs) can communicate with each other and other users via base stations 5 (and other access network nodes) and a core network 7 using an appropriate 3GPP radio access technology (RAT), for example, an Evolved Universal Terrestrial Radio Access (E-UTRA) and/or a 5G RAT. It will be appreciated that a number of base stations 5 form a (radio) access network or (R)AN. As those skilled in the art will appreciate, whilst four mobile devices 3A, 3B, 3C and 3D and two base stations 5A and 5B are shown in FIG. 1 for illustration purposes, the system, when implemented, will typically include other base stations/(R)AN nodes 5 and mobile devices (UEs) 3.

Each base station 5 controls one or more associated cells 6 (either directly or via other nodes such as home base stations, relays, remote radio heads, distributed units, and/or the like). In this example, a base station 5A has an area of direct coverage 6A-1 and a further area of coverage 6A-2 provided by a network controlled repeater (NCR) 9. The UE 3B in the further area of coverage 6A-2 provided by the NCR 9 is able to communicate with the base station 5a via the NCR 9.

A base station 5 that supports Next Generation/5G protocols may be referred to as a ‘gNB’. It will be appreciated that some base stations 5 may be configured to support both 4G and 5G, and/or any other 3GPP or non-3GPP communication protocols. It will be appreciated that a number of base stations 5 form a (radio) access network or (R)AN.

The mobile device 3 and its serving base station 5 are connected via an appropriate air interface (for example the so-called ‘NR’ air interface, the ‘Uu’ interface, and/or the like). Neighbouring base stations 5 may be connected to each other via an appropriate base station to base station interface (such as the so-called ‘Xn’ interface, the ‘X2’ interface, and/or the like). The base stations 5 are also connected to the core network nodes via an appropriate interface (such as the so-called ‘NG-U’ interface (for userplane), the so-called ‘NG-C’ interface (for control-plane), and/or the like).

The core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) 8-2 and one or more user plane functions (UPFs) 8-3. The core network 7 will also include the so-called Access and Mobility Management Function (AMF) 8-1 in 5G, or the Mobility Management Entity (MME) in 4G, that is responsible for handling connection and mobility management tasks for the mobile devices 3. The Session Management Function (SMF) 8-4 is responsible for handling communication sessions for the mobile devices 3 such as session establishment, modification and release. The Operations, Administration and Maintenance (OAM) function 8-5 may be implemented in software in one or more 5G CN nodes. The core network 7 is coupled to a data network 10, such as the Internet or a similar Internet Protocol (IP) based network.

When the UE 3 initially establishes an RRC connection with a base station 6 via a cell it registers with an appropriate AMF 8-1 (or MME). The UE 3 is in the so-called RRC connected state and an associated UE context is maintained by the network. When the UE 3 is in the so-called RRC idle or in the RRC inactive state, it still needs to select an appropriate cell for camping so that the network is aware of the approximate location of the UE 3 (although not necessarily on a cell level).

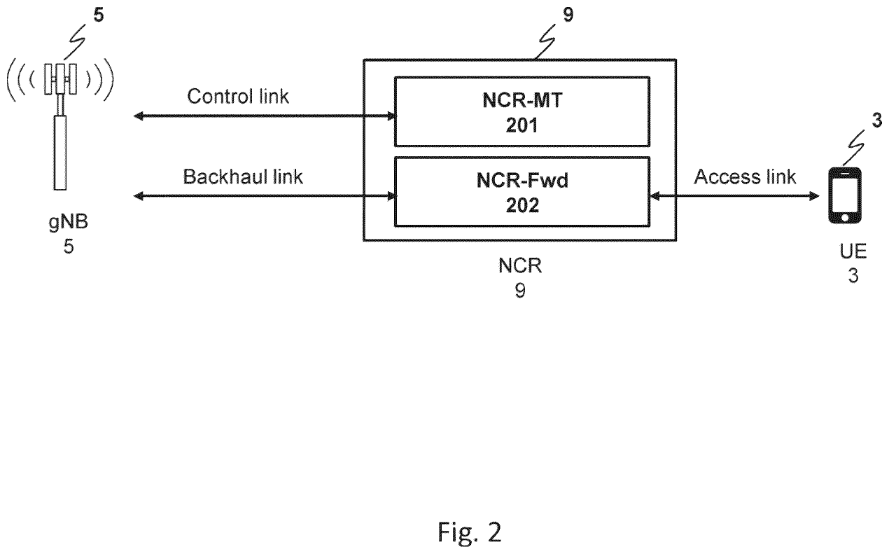

FIG. 2 shows a schematic diagram of the NCR 9 arranged between the base station 5 and the UE 3. The NCR 9 comprises an ‘NCR-Mobile termination’ (NCR-MT) 201 for communication with the base station 5 via a control link (including the reception of ‘side control information’, described in more detail below). The control link (C-link) is based on the new radio (NR) Uu interface. The NCR 9 also comprises an ‘NCRForwarding’ (NCR-Fwd) 202 for communication with the base station 5 via a backhaul link, and for communication with the UE 3 via an access link.

The NCR 9 receives control information from the gNB 5 related to at least one beamformed signal to be transmitted by the NCR 9. This control information may be referred to as ‘side control information’. The side control information includes control information for downlink (DL) and/or uplink (UL) transmissions. The behaviour of the NCR-Fwd 202 (e.g. one or more configurations of the NCR 9 related to the backhaul link and/or the access link) is controlled based on the side control information received from the gNB 5.

For DL transmissions, the repeater receives transmissions from the gNB 5 via the backhaul link, and transmits corresponding signals to the UE 3 via the access link. The side control information may control the direction, timing and frequencies of the transmissions on the access link to the UE 3. In other words, the side control information controls the forwarding of transmissions from the gNB 5 to the UE 3 by the NCR 9. The side control information may also indicate when a signal is to be received at the NCR 9 from the gNB via the backhaul. For UL transmissions, the NCR 9 receives transmissions from the UE 3 over the access link and transmits corresponding signals to the gNB 5. The side control information may control the direction on which the NCR 9 receives on the access link in a particular time and/or frequency resource window. The side control information may also indicate a time at which to receive a signal from the UE 3 via the access link.

The side control information may include configuration information for transmitting the beamformed signals and/or uplink/downlink (UL/DL) time division duplex (TDD) configuration information. The UL/DL TDD configuration information may indicate a semi-static TDD UL/DL configuration for the control link, backhaul link and/or the access link. The same TDD UL/DL configuration may be assumed for the backhaul link and the access link. The same TDD UL/DL configuration may be assumed for the control link, backhaul link and access link if the NCR-MT and the NCR-Fwd are in the same frequency band. More generally, the control information is used for controlling the forwarding behaviour, for UL and/or DL, of the NCR 9.

For downlink signal forwarding, the side control information may comprise information indicating one or more directions, for the access link, in which the NCR 9 is to transmit the signal received from backhaul link at a given time (e.g. time window). For uplink signal forwarding, the side control information may comprise information indicating one or more directions, for the access link, in which the NCR 9 is to receive the signal from the UE and forward to the gNB via the backhaul link at a given time (e.g. time window). The side control information may indicate different directions to be used at different times. The side control information may comprise information for a beam refinement procedure for a beam transmitted by the NCR 9. A beam refinement procedure may be used, for example, when the conditions of a radio link between the UE 3 and the NCR 9 change. The side control information may comprise beam information indicating a beam configuration for the access link. The side control information may comprise a direction in which a transmission from the UE 3 is to be received.

The side control information may comprise information regarding a semi-static and/or dynamic downlink/uplink configuration, adaptive transmitter/receiver spatial beamforming, ON-OFF information (e.g. for more efficient interference management and improved energy efficiency), power control information (e.g. for improved interference management), or any other suitable control information. The ON-OFF information may be for controlling the behaviour of the NCR-Fwd 202, and may include an explicit indication of an ON-OFF state or an ON-OFF pattern. The ON-OFF information may comprise an implicit indication via signalling for other information such as beam information, DL/UL configuration information, or power control information. The ON-OFF information may comprise a combination of an explicit indication and an implicit indication.

The side control information may comprise timing information to indicate when the NCR 9 is to amplify and forward signals for downlink and/or uplink. The timing information may be for configuring the DL receiving timing of the NCR-Fwd at the backhaul link. The timing information may also, or alternatively, be for configuring the UL receiving timing of the NCR-Fwd at the access link. The NCR-Fwd 202 amplifies and forwards the corresponding received signal to UE 3 in the downlink case, or to the gNB 5 in uplink case.

The side control information may be transmitted from the gNB 5 to the NCR 9 as L1/L2 control signaling and/or as RRC signalling. The NCR 9 may obtain configuration information for receiving the L1/L2 signalling via radio resource control (RRC) signalling. Alternatively, the configuration information for receiving the L1/L2 signalling may be received from an operations administration and maintenance (OAM) entity in the network, or may be preconfigured at the NCR 9. In a further alternative, the configuration information for receiving the L1/L2 signalling may be partially received via RRC signalling and partially received from the OAM entity in the network. The configuration information for receiving the L1/L2 signalling may comprise configuration information for receiving physical downlink control channel (PDCCH) and/or physical downlink shared channel (PDSCH), configuration information for transmitting physical uplink control channel (PUCCH), configuration information for transmitting physical uplink shared channel (PUSCH), configuration information for downlink control information (DCI), configuration information for uplink control information (UCI), and/or configuration information for medium access control control-element (MAC CE).

### User Equipment (UE)

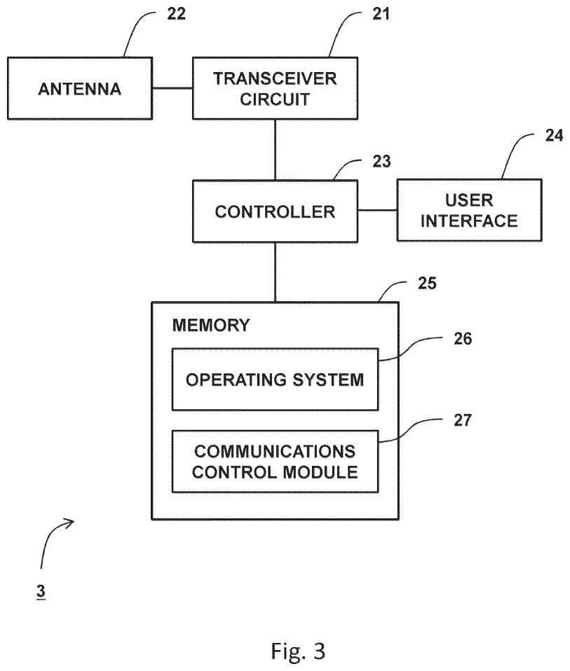

FIG. 3 is a block diagram illustrating the main components of the mobile device (UE) 3 shown in FIG. 1. As shown, the UE 3 includes a transceiver circuit 21 which is operable to transmit signals to and to receive signals from one or more connected nodes via one or more antennas 22. Although not necessarily shown in FIG. 3, the UE 3 will of course have all the usual functionality of a conventional mobile device (such as a user interface 24) and this may be provided by any one or any combination of hardware, software and firmware, as appropriate. A controller 23 controls the operation of the UE 3 in accordance with software stored in a memory 25. The software may be pre-installed in the memory 25 and/or may be downloaded via the telecommunication network 1 or from a removable data storage device (RMD), for example. The software includes, among other things, an operating system 26, a communications control module 27.

The communications control module 27 is responsible for handling (generating/sending/receiving) signalling messages and uplink/downlink data packets between the UE 3 and other nodes, including (R)AN nodes 6, the NCR 9, and core network nodes. The signalling may comprise control signalling (such as RRC signalling) related to configuring and assisting cell reselection by the UE 3.

The UE 3 may receive one or more beamformed signals (e.g. a beamformed signal transmitted by the NCR 9) and may perform corresponding signal strength measurements. The UE 3 may determine to communicate using a particular one of the beams (e.g. the beam having the strongest signal received at the UE during a measurement period). The beam selected by the UE 3 can be identified using the corresponding index (e.g. a syncronisation signal block (SSB) index, or any other suitable index) and used for communication, either directly between the base station 5 and the UE 3 or via the NCR 9 (when the index corresponds to a beam that was transmitted by the NCR 9).

### Base Station/Gateway (Access Network Node)

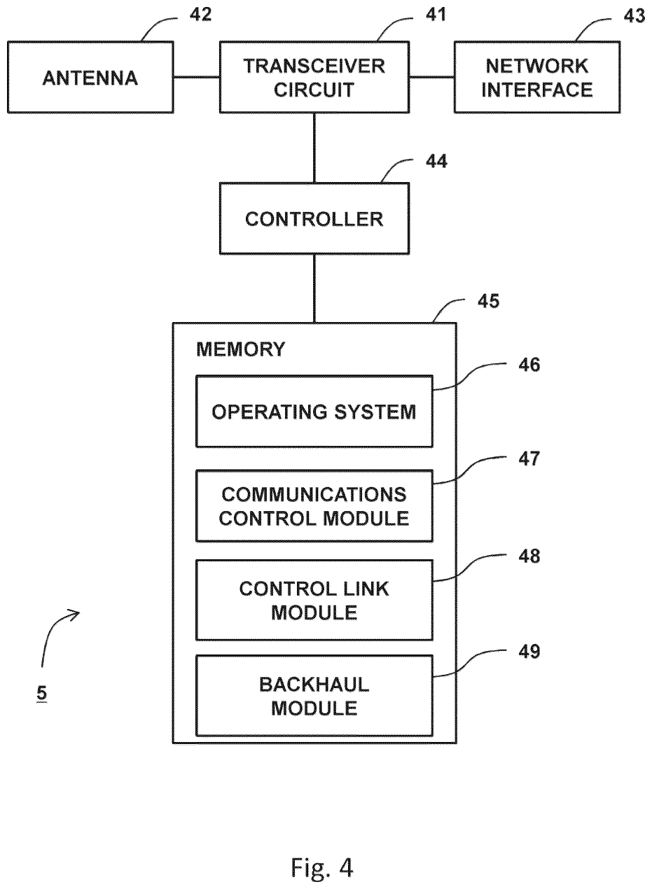

FIG. 4 is a block diagram illustrating the main components of the gateway/base station 5 shown in FIG. 1 (a base station (gNB) or a similar access network node; the base station need not necessarily be a gNB). As shown, the base station 5 includes a transceiver circuit 41 which is operable to transmit signals to and to receive signals from one or more UEs 3 or the NCR 9 via one or more antennas 42 and to transmit signals to and to receive signals from other network nodes (either directly or indirectly) via a network interface 43. The network interface 43 typically includes an appropriate base station—base station interface (such as X2/Xn) and an appropriate base station—core network interface (such as S1/NG-C/NG-U). A controller 44 controls the operation of the base station 5 in accordance with software stored in a memory 45. The software may be pre-installed in the memory 45 and/or may be downloaded via the telecommunication network or from a removable data storage device (RMD), for example. The software includes, among other things, an operating system 46, a communications control module 47, a control link module 48 and a backhaul module 49.

The communications control module 47 is responsible for handling (generating/sending/receiving) signalling between the base station 5 and other nodes, such as the UE 3 and core network nodes. The signalling may comprise, for example, control signalling (such as RRC signalling) related to configuring and assisting cell reselection by the UE 3.

The control link module 48 is responsible for controlling communication via the control link with the NCR-MT 201 of the NCR 9. It will be appreciated that the control link module 48 may be configured to control the communication over the control link according to any of the examples described below.

The backhaul module 49 is responsible for controlling communication via the backhaul with the NCR-Fwd 202 of the NCR 9. It will be appreciated that the backhaul module 49 may be configured to control the communication over the backhaul according to any of the examples described below.

### Network Controlled Repeater (NCR)

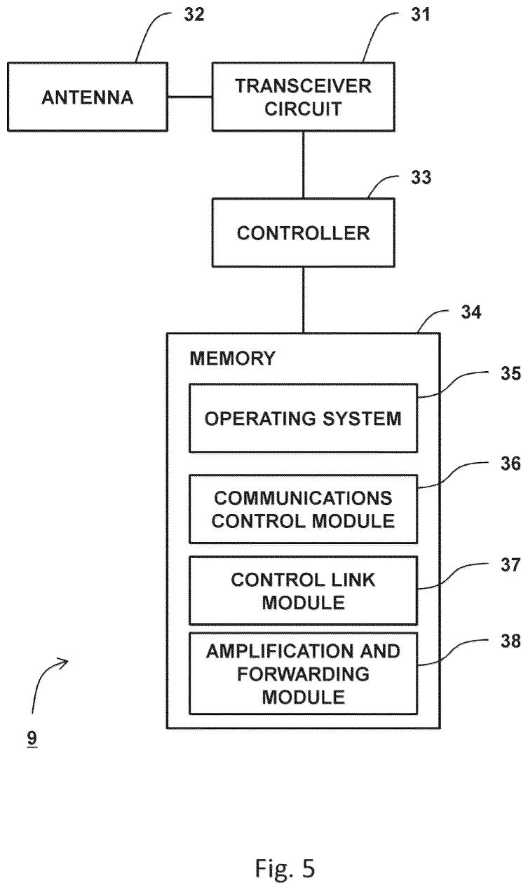

FIG. 5 is a block diagram illustrating the main components of the NCR 9 shown in FIG. 1. As shown, the NCR 9 includes a transceiver circuit 31 which is operable to transmit signals to and to receive signals from one or more UEs 3 and the base station 5 via one or more antennas 32. A controller 33 controls the operation of the NCR 9 in accordance with software stored in a memory 34. The software may be pre-installed in the memory 34 and/or may be downloaded via the telecommunication network or from a removable data storage device (RMD), for example. The software includes, among other things, an operating system 35, a communications control module 36, a control link module 37 and an amplification and forwarding module 38.

The communications control module 36 is responsible for overall handling (generating/sending/receiving) of signalling between the base station 5 and the UE 3.

The control link module 37 is responsible for controlling communication via the control link with the base station 5. It will be appreciated that the control link module 37 may be configured to control the communication over the control link according to any of the examples described below. The control link module 37 may be the NCR-MT 201 illustrated in FIG. 2.

The amplification and forwarding module 38 is responsible for controlling communication with the base station 5 via the backhaul, and for controlling communication with the UE 3 via the access link. It will be appreciated that the amplification and forwarding module 38 may be configured to control the communication over the backhaul and the access link according to any of the examples described below. The amplification and forwarding module 38 may be the NCR-Fwd 202 illustrated in FIG. 2.

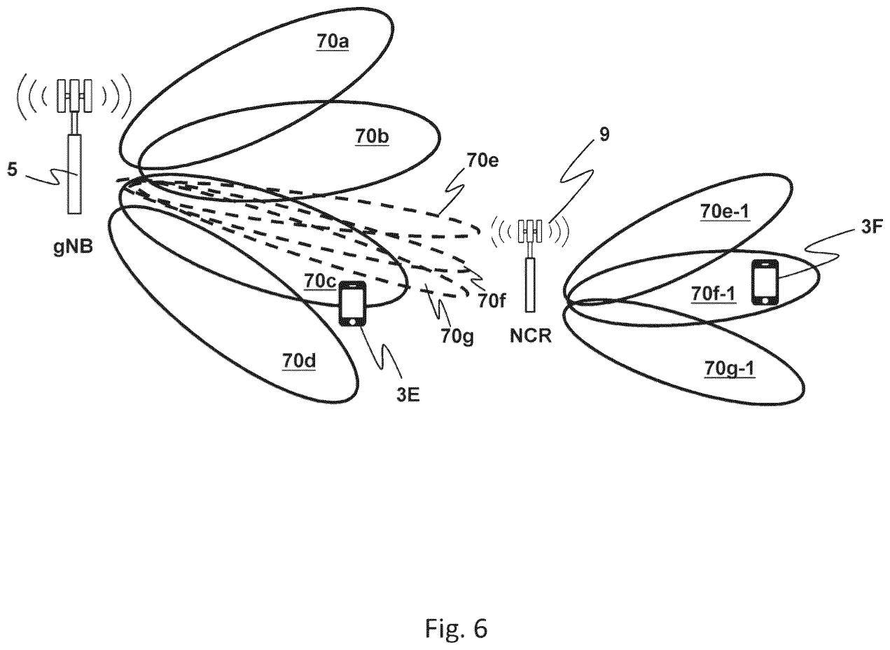

A received broadcast signal may be relayed over the access link multiple times by the NCR 9 within a pre-configured time window, but in different beam directions, thereby achieving a ‘beam sweeping’ effect (illustrated in FIG. 6).

The NCR 9 may be transparent to the UEs 3 in the system 1. The NCR 9 may be configured to maintain the gNB-repeater link (e.g. the backhaul link and/or the control link) and the repeater-UE link (the access link) simultaneously.

### NCR Forwarding Overview

FIG. 6 shows an example of communication between a gNB 5 and a UE 3F via an NCR 9.

As shown in FIG. 6, the base station 5 transmit signals over a plurality of beam directions 70a-70g. Each beam 70a-70g may have a corresponding index for identifying the beam. For SSB transmissions, the index may be an SSB index. In the example shown in FIG. 6, beams 70a to 70d are transmitted by the gNB 5. Each beam 70a-70d is transmitted at a different beam direction using different time resources to achieve a beam sweeping effect. Whilst each beam 70a-70d is transmitted in a generally different direction, it will be appreciated that there may be some spatial overlap between the beams, as illustrated in FIG. 6 in which, for example, beam 70b partially overlaps beams 70a and 70c). For SIB1/SI/paging transmission, there may be one or multiple beam sweeping cycles within a SIB1/SI/paging transmission window/transmission occasion. The gNB 5 also transmits beams 70e to 70g which are beamformed towards the NCR 9, for subsequent forwarding by the NCR 9 as the corresponding beams 70e-1 to 70g-1.

SSB beams may be transmitted in the time domain as a group of SSB transmissions, which may be referred to as an ‘SSB burst set’. Each SSB in the SSB burst set may be referred to as an ‘SSB block’. For example, a 5 ms SSB burst set in which SSB beams 70a to 70d are transmitted by the gNB 5 sequentially within a 5 ms time period may be used, resulting in the ‘beam sweeping’ effect. However, the burst set need not necessarily be of 5 ms duration. Various other transmission configurations in the time domain may be used depending on the configuration of the gNB 5 and the available communication resources. Moreover, whilst in the example shown in FIG. 6 the gNB 5 transmits four SSB, the number of SSB need not necessarily be four. The number of SSB could alternatively be less than or equal to 3, or greater than or equal to 5 (for example, up to 64 SSB blocks within an SSB burst set).

In the example of FIG. 6, a first UE 3E is located within the coverage area of SSB 70c transmitted by the gNB 5. The second UE 3F is located within the coverage area of SSB 70f-1 transmitted (forwarded) by the NCR 9, and can communicate with the gNB 5 via the NCR 9, by communicating with the NCR 9 over the access link (and by virtue of communication between the NCR 9 and the gNB 5 via the backhaul link).

The first UE 3E receives the signal corresponding to SSB 70c, and may also receive signals corresponding to the other SSB (e.g. the neighbouring SSB 70b and 70d). The UE 3E and the gNB 5 may perform an initial access procedure after the UE 3E has received one of the beamformed signals transmitted by the gNB 5, and the UE 3E may be configured to transmit a corresponding measurement report to the gNB 5. The UE 3E may perform measurements of, for example, syncronisation signal RSRP (SS-RSRP) or physical broadcast channel demodulation reference signal (PBCH DMRS). The UE 3E may be configured to determine an SSB index corresponding to a beam by decoding the PBCH DMRS. The UE 3E may determine a particular beam (and/or corresponding time or frequency resource) to be used for communication with the gNB 5 based on corresponding signal measurements performed by the UE 3E. Alternatively, the UE 3E may report the measurements to the gNB 5, and the gNB 5 may determine the beam (and/or corresponding time or frequency resource) to be used for communication with the UE 3E.

In this example, the second UE 3F is not within the coverage area of a beam transmitted directly by the gNB 5, because the UE 3F is located outside of the unextended range of the gNB 5. However, the second UE 3F is within the coverage area of beam 70f-1 transmitted by the NCR 9.

The NCR 9 receives the signals transmitted over the beams 70e-70g by the gNB 5. The NCR-MT 201 determines the receive time windows corresponding to the beams (e.g. the receive time windows for SI, SIB1, and/or paging). The receive time windows correspond to the transmit time windows for the determined beamformed signal.

The NCR-MT 201 determines how and when to forward beamformed signal via the access link to the UE 3. In other words, the NCR-MT 201 determines the spatial, frequency and time resources to use to transmit one or more forwarded beams. The determination of how and when to forward the beams may be based on the side control information received from the gNB 5 via the control link.

### NCR Procedure Overview

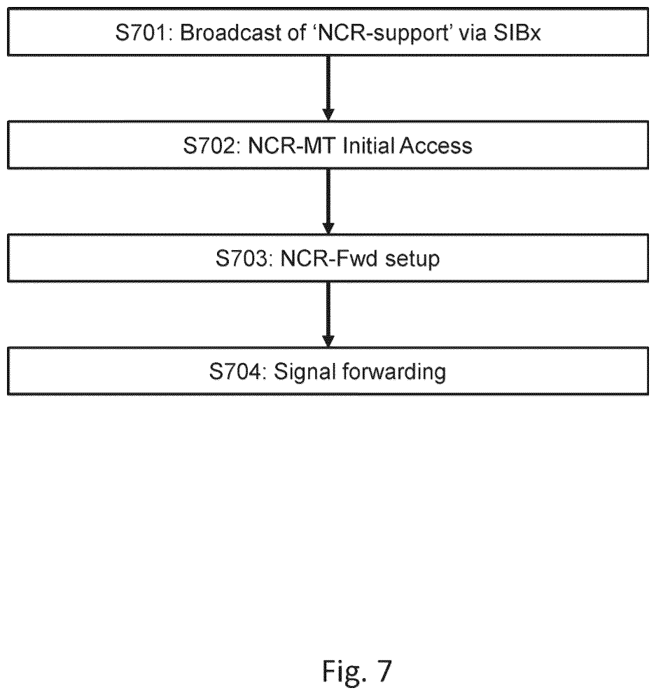

An overview of an NCR procedure will now be described, with reference to FIG. 7 which shows an overall procedure from the broadcast of ‘NCR-support’ via SIBx, to signal forwarding by the NCR 9.

In step S701, the gNB 5 broadcasts ‘NCR-support’ via system information block x (SIBx). For example, the gNB 5 may broadcast NCR-support via SIB1. The information element (IE) type of NCR-support is ‘true’. For the case of multiple Public Land Mobile Networks (PLMNs) indicated in SIB1, this field is common for all PLMNs.

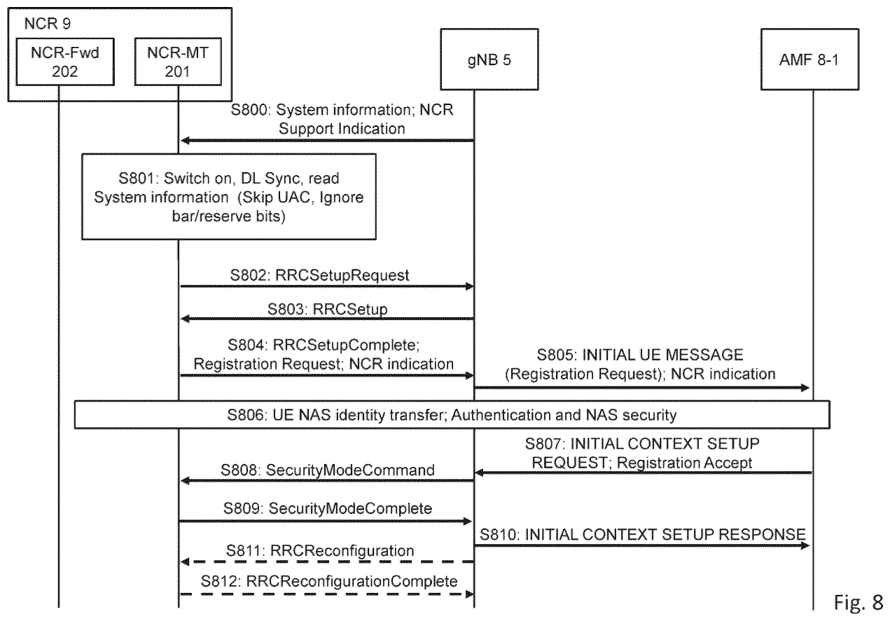

In step S702, an NCR-MT initial access step is performed. At this stage of the procedure, the access link between the NCR 9 the UE 3 is not ready for the forwarding of data. The NCR-MT 201 starts a registration/attach procedure in a cell that broadcasts ‘NCR-support’=‘true’. For NCR-MT 201, cellBarred, cellReservedForOperatorUse and cellReservedForOtherUse are ignored, and unified access control (UAC) is skipped. The NCR-MT initial access procedure will be described in more detail below with reference to FIG. 8.

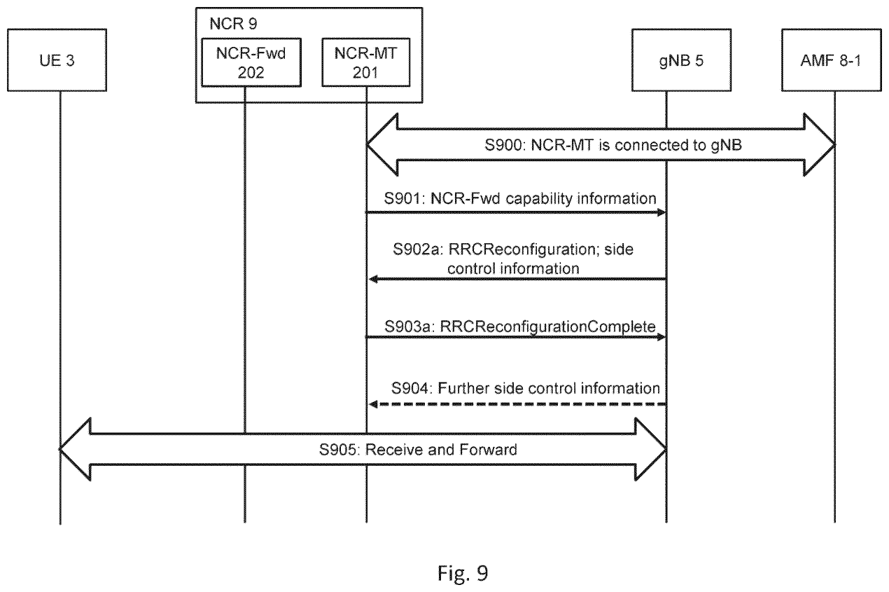

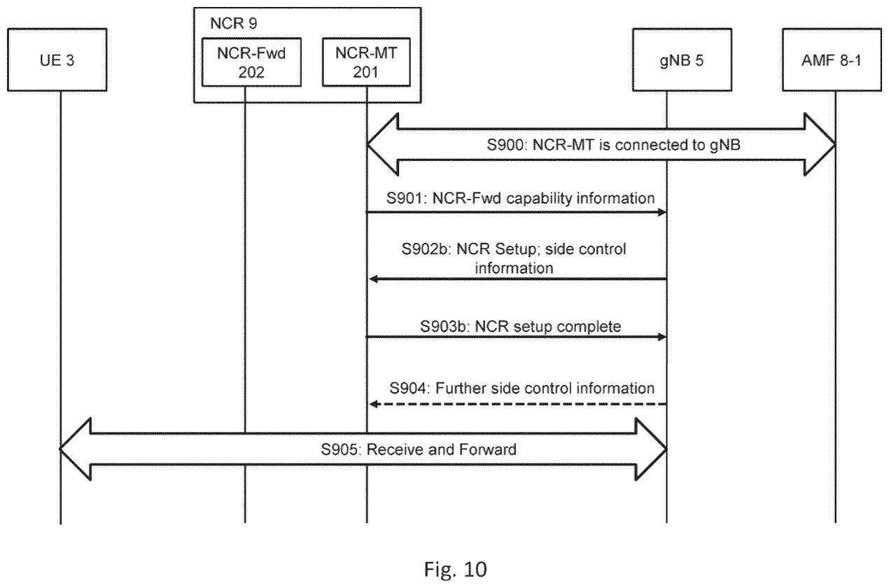

In step S703, an NCR-Fwd setup step is performed. As will be described below with reference to FIGS. 9 and 10, the method may comprise reusing RRCConnectionReconfiguration, or may alternatively use a new ‘NCR setup’ procedure for NCR-Fwd 202 initialisation.

To initialise the NCR 9, NCR capability may be reported, including how many SSBs to use for beam sweeping in the coverage area of the NCR 9. Initial side control information may be transmitted that includes one or both of: a list of SSB-Index for repeater coverage; or Initial on-off of Fwd and corresponding beam forming information at different time windows.

NCR-Fwd 202 is activated after the NCR-Fwd setup phase is completed. NCR-Fwd 202 may be activated upon ‘reconfiguration complete’, or ‘NCR setup complete’.

In step S704, a signal forwarding step is performed. In this step, the NCR 9 may receive further side control information from the gNB 5 and controls the NCR-Fwd access link.

### NCR-MT Initial Access Procedure

The NCR-MT Initial Access procedure will now be described with reference to FIG. 8.

The procedure illustrated in FIG. 8 is based on the initial access and initial attach procedure between a UE 3 and a gNB 5 (see for example NPL 4), but is modified to advantageously include an indication of NCR support in the system information transmitted by the gNB 5, and an NCR indication from the NCR 7.

In step S800, the gNB 5 transmits system information to the NCR-MT 201. Advantageously, the system information includes an NCR support indication, enabling the NCR-MT 201 to determine whether the gNB 5 supports NCR 9. The gNB 5 broadcasts ‘NCR-support’ via an appropriate system information block (SIB). For example, the gNB 5 may broadcast an NCR support indication (e.g., an ‘NCR-support’ information element (IE)) via SIB1. In this example, the NCR-support is set to ‘true’, indicating that NCR 9 is supported (or a specific functionality of the NCR is supported) by the gNB 5 (alternatively, NCR-support may be ‘false’, indicating that NCR 9 is not supported by the gNB 5), although it will be appreciated that any suitable indication (explicit or implicit) of NCR support may be used. For the case of multiple Public Land Mobile Network (PLMN) indicated in SIB1, this field is common for all PLMN.

In step S801, switch on, downlink (DL) syncronisation, and reading of the system information received from the gNB 5 is performed. Unified access control (UAC) is skipped, and bar/reserve bits (e.g., bits indicating access/cell barring and/or cell reservation) are ignored.

In step S802, an RRC setup request message is transmitted from the NCR-MT 201 to the gNB 5.

In step S803, an RRC setup message is transmitted from the gNB 5 to the NCR-MT 201.

In step S804, an RRC setup complete message including a registration request and an NCR indication is transmitted to the gNB 5. Advantageously, the NCR indication is used by the NCR 9 to indicate that it is an NCR to the gNB 5.

In step S805, an INITIAL UE MESSAGE is transmitted from the gNB 5 to the AMF 8-1. The gNB 5 may also transmit the registration request and the NCR indication to the AMF 8-1.

In step S806, UE NAS identity transfer, Authentication and NAS security processing is performed.

In step S807, the AMF 8-1 transmits INITIAL CONTEXT SETUP REQUEST and registration accept to the gNB 5.

In step S808 the gNB 5 transmits a security mode command to the NCR-MT 201.

In step S809, the NCR-MT 201 transmits a security mode complete to the gNB 5.

In step S810, the gNB 5 transmits INITIAL CONTEXT SETUP RESPONSE to the AMF 8-1.

In optional step S811, the gNB 5 transmits an RRC reconfiguration message to the NCR-MT 201.

In optional step S812, the NCR-MT 201 transmits RRC reconfiguration complete to the gNB 5.

During the registration/attach, there are two options for identifying the NCR-MT type to the gNB 5. In the first option, the NCR-MT 201 sets the content of the RRC setup complete message with the NCR node indication (e.g., as described above). In the second option, the NCR-MT 201 compiles and transfers the NCR node indication associated with its radio UE capability information, for example, upon receiving a UE capability enquiry from the gNB.

For protocol data unit (PDU) session configuration, data radio bearer (DRB) configuration and the Ng interface there are two options. In the first option (which may be referred to as the legacy option), the Ng interface is established and the PDU session and default DRB/SRB2 are set up. In the second option, the gNB 5 stores the UE context, but without the Ng connection and without the PDU session configuration or DRB configuration. In the second option, signaling radio bearer 2 (SRB2) may also not be needed.

### NCR-Fwd Setup Procedure

NCR forwarding is setup using an NCR-Fwd setup procedure, which will now be described with reference to FIG. 9.

In the NCR-Fwd setup procedure, RRC signalling is beneficial for the initial side control information, since this information is semi-persistent/static, and is relevant to always-on/common channels of a cell. At least some of the RRC side control information may be indicated implicitly by a list of SSB indices. Alternatively, or additionally, at least some of the RRC side control information may be indicated explicitly, for example by indicating one or more of indices, a timing information field, and/or a beam information field. The index may be provided for further updates to the configuration. For example, updating the beam information due to UE movement, and either maintaining the same time/frequency information or releasing the configuration. The timing (frequency) information field may indicate a time at which the repeater is to relay the signal between the gNB 5 and the UE 3. The timing information may correspond to a repeatable pattern. The beam information field may indicate a beam direction to be used for transmission/reception on the access link. The beam direction information can be used in combination with a time/frequency indicated by the timing information field.

Initially, the NCR 9 has informed the gNB 5 that it is an NCR, and additionally (or alternatively) how many SSB/beams for repeater coverage sweeping are available. This information may be indicated in the ‘NCR indication’ shown in step S804 in FIG. 8. The NCR indication may also include any other suitable information regarding the NCR 9 (e.g. information regarding a capability of the NCR 9).

In step S900, the NCR-MT is connecting to the gNB 5 after finishing the NCR-MT Initial Access Procedure illustrated in in FIG. 8.

In step S901, the NCR-MT 201 transmits NCR-Fwd (all or further) capability information to the gNB 5. Advantageously, the NCR-Fwd may indicate a number of SSB (e.g. a number of SSB supported by the NCR 9), and/or antenna information of the NCR 9. Beneficially, the gNB 5 is able to more efficiently and effectively configure the NCR 9 based on the received NCR0Fwd capability information.

In step S902a, the gNB 5 transmits an RRC reconfiguration message including (initial) side control information to the NCR-MT 201.

In step S903a, the NCR-MT 201 transmits a RRCReconfigurationComplete message to the gNB 5.

In optional step S904, the gNB 5 may transmit further side control information to the NCR-MT 201.

In step S905, a receive and forward procedure is performed. In the receive and forward procedure, the NCR 9 receives transmissions from the gNB 5 on the backhaul link and forwards the transmissions to the UE 3 on the access link. Similarly, the NCR 9 receives transmissions from the UE 3 on the access link and forwards the transmissions to the gNB 5 via the backhaul link. In step S905 the NCR 9 may receive and forward downlink SSBs (e.g. SSB #a/b/c), SIB1, system information (SI) and/or paging information during paging occasions (POs) on the downlink. On the uplink, the NCR 9 may receive and forward uplink information during POs corresponding to the SSB (e.g. SSB #a/b/c).

An alternative NCR-Fwd setup procedure is shown in FIG. 10. In the example of FIG. 10, steps S902a and S903a are replaced with steps S902b and S903b. The remaining steps shown in FIG. 10 are the same as the corresponding steps shown in FIG. 9.

Instep S902b, the gNB 5 transmits a new NCR Setup message comprising side control information to the NCR-MT 201, for initialisation of the NCR-Fwd 202.

In step S903b, the NCR-MT transmits an NCR setup complete message to the gNB 5, indicating that the initialisation of the NCR-Fwd 202 is complete. Advantageously, therefore, by exchanging the new NCR Setup and NCR setup complete messages, the gNB 5 and NCR 9 are able to more efficiently exchange information regarding the NCR 9.

In both of the examples shown in FIGS. 9 and 10 the message 902a/b and 903a/b are for determining the time and frequency information for the common channels that are to be received and forwarded by the NCR 9.

After completion of the NCR-Fwd set up phase, NCR-Fwd is activated. In other words, NCR-Fwd is activated upon the reception of RRCReconfigurationComplete or ‘NCR setup complete’.

### Side Control Information Addition/Update/Release Procedure

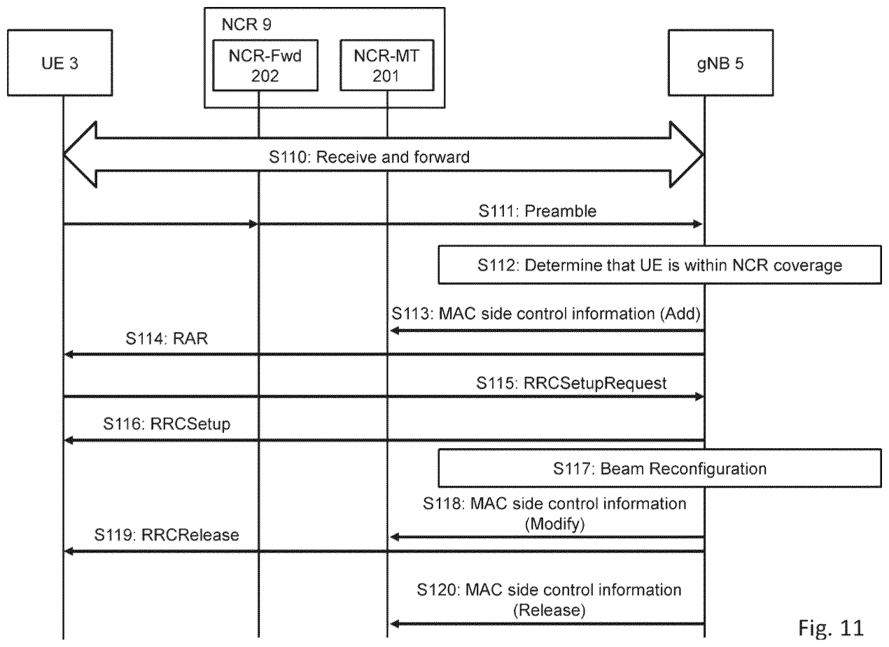

A side control information update procedure as a consequence of UE 3 access/release via NCR will now be described with reference to FIG. 11.

In the method shown in FIG. 11, side control information is transmitted to configure the timing at which the NCR-Fwd is to relay the signal, and to provide an indication of a direction in which to relay (beamforming information) or to receive in uplink. For example, the beamforming information may indicate a direction that corresponds to the location of a particular UE 3.

Advantageously, medium access control (MAC) signalling is used for the transmission of the side control information. MAC signalling is advantageous because the side control information is exchanged relatively frequently, it is relevant to scheduling and beamforming, and the number of bits of side control information is not too small.

The MAC Control Element (MAC CE) may comprise an index that indicates further updates to the configuration. For example, updating the beam information due to UE movement while maintaining the same time/frequency information, or releasing the configuration. The timing (frequency) information field may indicate a time at which the repeater is to relay the signal between the gNB 5 and the UE 3. The timing information may correspond to a repeatable or periodic pattern. The timing information may correspond to downlink (DL) or uplink (UL) subframes, slots and/or symbols. The beam information field may indicate a beam direction to be used for transmission/reception on the access link. The beam direction information can be used in combination with a time/frequency indicated by the timing information field.

In step S110, a receive and forward procedure is being performed by NCR-Fwd 202 based on previously received side control information. In the receive and forward stage, the NCR 9 receives transmissions from the gNB 5 on the backhaul link and forwards the transmissions to the UE 3 on the access link. Similarly, the NCR 9 receives transmissions from the UE 3 on the access link and forwards the transmissions to the gNB 5 via the backhaul link. For example, the receive and forward procedure may receive and forward downlink SSBs (e.g. SSB #a/b/c), SIB1, system information (SI) and/or paging information during paging occasions (POs) on the downlink. On the uplink, the NCR 9 may receive and forward uplink information during POs corresponding to the SSB (e.g. SSB #a/b/c).

In step S111, a preamble is transmitted from the UE 3 to the gNB 5, via the NCR-Fwd 202.

In step S112, the gNB 5 determines (e.g., based on the preamble) that the UE 3 is located with the coverage area of the NCR 9. The gNB 5 is advantageously able to determine that the UE 3 is located within the coverage area of the NCR 9, based on a PRACH occasion where the preamble is received, when the PRACH occasion corresponds to the SSBs used for the NCR 9 coverage (e.g. SSBs 70e-1 to 70g-1 illustrated in FIG. 6).

In step S113, the gNB 5 transmits MAC side control information (Add) to the NCR-MT 201 to indicate additional time when NCR should relay the signal in the uplink and/or downlink. For the downlink relay, the MAC side control information may indicate in which beam direction NCR-Fwd is to relay the received signal in the aforementioned additional time. For uplink relay the MAC side control information may indicate in which beam direction NCR-Fwd receives the signal in the aforementioned additional time, and then forwards to the gNB. This enables NCR relay signalling.

In step S114 the gNB 5 transmits a random access response (RAR) to the UE 3.

In step S115, the UE 3 transmits an RRCSetupRequest to the gNB 5.

In step S116, the gNB 5 transmits an RRCSetup message to the UE 3.

In step S117, the gNB 5 performs the Beam Reconfiguration procedure. The UE beam is reconfigured based on the measurement configuration/report.

In step S118 the gNB 5 transmits MAC side control information (Modify) to the NCR-MT 201 to modify e.g., the beam direction configured of S113.

In step S119 the gNB 5 transmits an RRCRelease message to the UE 3.

In step S120 the gNB 5 transmits a MAC side control information (Release) message to the NCR-MT 201 to release e.g., the side control information configured in steps S113 and S118.

It should be noted that steps S113, S118 and S120 may be performed at any time during the NCR data forwarding stage, and the above described sequence of method steps is an example of when side control information reconfiguration/update may be triggered by UE access, moving and release.

### Timing Information

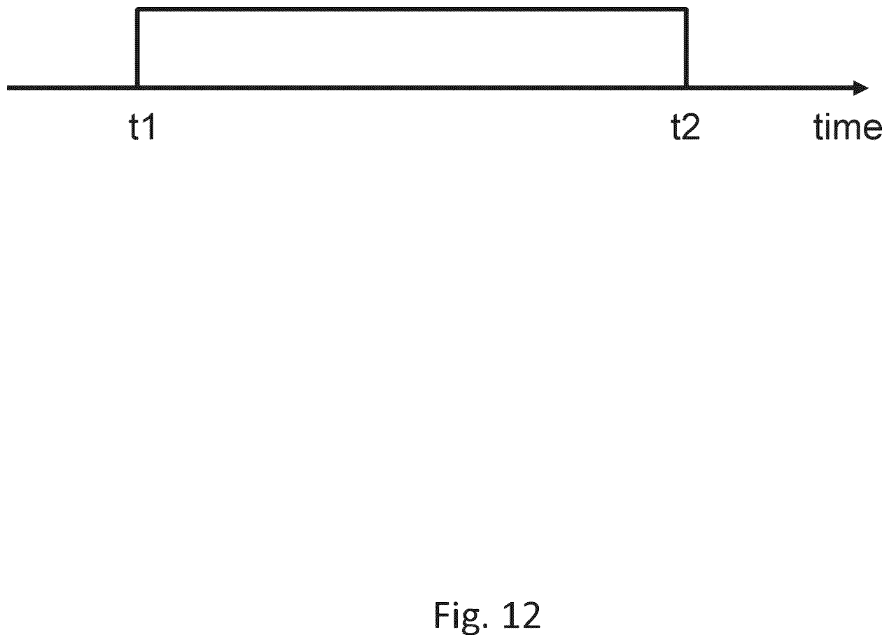

Examples of information that may be indicated in the above-described timing information (e.g. in the MAC CE described with reference to FIG. 11 or in RRC signalling described with reference to FIG. 9 and FIG. 10) will now be described, with reference to FIGS. 12 to 14.

FIG. 12 shows an example of a time window between time t1 and time t2 that may be indicated by the timing information, for use by the NCR 9 (e.g. for reception/transmission ON/OFF control for relaying signals between the UE 3 and the gNB 5).

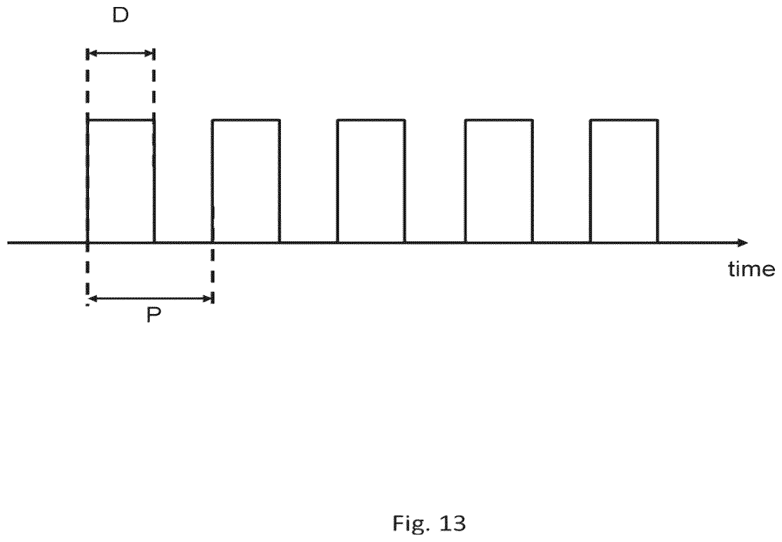

FIG. 13 shows an example of a periodic time window having a duration D and a periodicity P that may be indicating by the timing information (similar to discontinuous reception (DRX)), for use by the NCR 9 (e.g. for reception/transmission ON/OFF control for relaying signals between the UE 3 and the gNB 5).

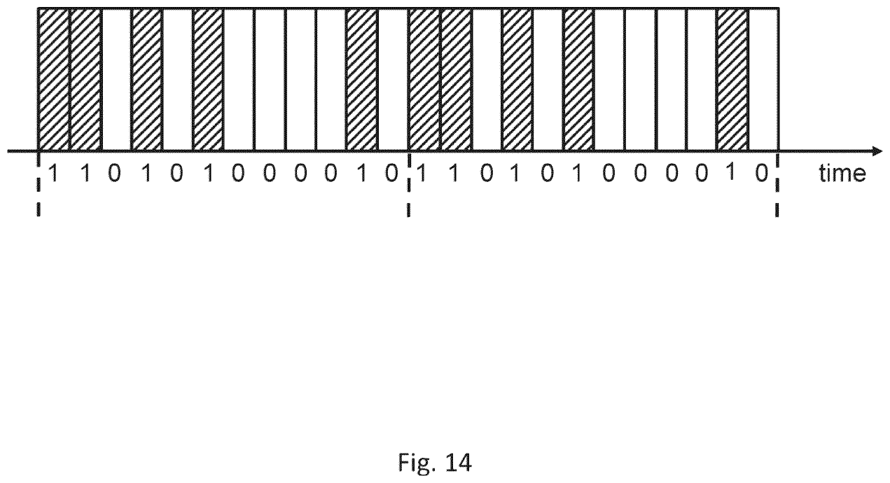

FIG. 14 shows an example of a repeatable bitmap that may be used to indicate an on/off pattern, for use by the NCR 9 (e.g. for reception/transmission ON/OFF control for relaying signals between the UE 3 and the gNB 5). In this example, a value of ‘1’ corresponds to ‘ON’, and a value of ‘0’ corresponds to ‘OFF’. In this example, the NCR 9 receives information indicating the string ‘11010100001’, corresponding to a sequence of ‘ON’ periods and ‘OFF’ periods.

The granularity for each of the examples illustrated in FIG. 12 to 14 may be at the symbol, slot or subframe level. These options are not mutually exclusive, and each option may be useful in a particular scenario.

### Modifications and Alternatives

Detailed example embodiments have been described above. As those skilled in the art will appreciate, a number of modifications and alternatives can be made to the above example embodiments whilst still benefiting from the disclosures embodied therein. By way of illustration only a number of these alternatives and modifications will now be described.

Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). NPL 5 and NPL 6 define the following nodes, amongst others:

gNB: node providing NR user plane and control plane protocol terminations towards the UE, and connected via the NG interface to the 5G core network (5GC).

ng-eNB: node providing E-UTRA user plane and control plane protocol terminations towards the UE, and connected via the NG interface to the 5GC.

En-gNB: node providing NR user plane and control plane protocol terminations towards the UE, and acting as Secondary Node in E-UTRA-NR Dual Connectivity (EN-DC).

NG-RAN node: either a gNB or an ng-eNB.

It will be appreciated that the above example embodiments may be applied to both 5G New Radio and LTE systems (E-UTRAN). A base station (gateway) that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

Each cell may have an associated ‘NR Cell Global Identifier’ (NCGI) to identify the cell globally. The NCGI is constructed from the Public Land Mobile Network (PLMN) identity (PLMN ID) the cell belongs to and the NR Cell Identity (NCI) of the cell. The PLMN ID included in the NCGI is the first PLMN ID within the set of PLMN IDs associated to the NR Cell Identity in System Information Block Type 1 (SIB1). The ‘gNB Identifier’ (gNB ID) is used to identify a particular gNB within a PLMN. The gNB ID is contained within the NCI of its cells. The ‘Global gNB ID’ is used to identify a gNB globally and it is constructed from the PLMN identity the gNB belongs to and the gNB ID. The Mobile Country Code (MCC) and Mobile Network Code (MNC) are the same as included in the NCGI.

In the above description, the UE 3, the access network node (base station 5) and the NCR 9 are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware, or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above example embodiments, a number of software modules were described. As those skilled in the art will appreciate, the software modules may be provided in compiled or un-compiled form and may be supplied to the UE 3, NCR 9 or base station 5 as a signal over a computer network, or on a recording medium. Further, the functionality performed by part or all of this software may be performed using one or more dedicated hardware circuits. However, the use of software modules is preferred as it facilitates the updating of the UE 3, NCR 9 or base station 5 in order to update their functionalities.

The above example embodiments are also applicable to ‘non-mobile’ or generally stationary user equipment 3. The above-described mobile device (UE) 3 may comprise an MTC/IoT device, a power saving UE, and/or the like.

The User Equipment 3 (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; (motor) vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to ‘internet of things’ (IoT), using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table (source: NPL 7, Annex B, the contents of which are incorporated herein by reference). This list is not exhaustive and is intended to be indicative of some examples of machine type communication applications.

| Service Area | MTC applications |
|---|---|
| Security | Surveillance systems |
| | Backup for landline |
| | Control of physical access |
| | (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/Control | Sensors |
| | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an Mobile Virtual Network Operator (MVNO) service, an emergency radio communication system, a Private Branch exchange (PBX) system, a PHS/Digital Cordless Telecommunications system, a Point of sale (POS) system, an advertise calling system, a Multimedia Broadcast and Multicast Service (MBMS), a Vehicle to Everything (V2X) system, a train radio system, a location related service, a Disaster/Emergency Wireless Communication Service, a community service, a video streaming service, a femto cell application service, a Voice over LTE (VOLTE) service, a charging service, a radio on demand service, a roaming service, an activity monitoring service, a telecom carrier/communication NW selection service, a functional restriction service, a Proof of Concept (PoC) service, a personal information management service, an ad-hoc network/Delay Tolerant Networking (DTN) service, etc.

Further, the above-described UE categories are merely examples of applications of the technical ideas and example embodiments described in the present document. Needless to say, these technical ideas and example embodiments are not limited to the above-described UE and various modifications can be made thereto.

Various other modifications will be apparent to those skilled in the art and will not be described in further detail here.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes.

### (Supplementary Note 1)

A method performed by a network controlled repeater, NCR, the method comprising:
receiving, from an access network node, an NCR support indication that indicates whether a function of the NCR is supported by the access network node; and
transmitting, to the access network node, in a case where the NCR support indication indicates that the function of the NCR is supported by the access network node, an NCR device indication that indicates that the NCR is an NCR device.

### (Supplementary Note 2)

The method according to Supplementary Note 1, further comprising:
transmitting, to the access network node, in a case where the NCR support indication indicates that the function of the NCR is supported by the access network node, a request to set up a radio resource control, RRC, connection;
receiving, from the access network node, a response to the request to set up the RRC connection; and
transmitting an RRC message to the access network node, wherein the RRC message includes the NCR device indication.

### (Supplementary Note 3)

The method according to Supplementary Note 1, further comprising:
transmitting, to the access network node, an indication corresponding to radio capability information of the NCR;
wherein the indication corresponding the radio capability information of the NCR includes the NCR device indication.

### (Supplementary Note 4)

The method according to any preceding Supplementary Note, wherein the NCR support indication is received from the access network node as part of system information transmitted by the access network node.

### (Supplementary Note 5)

The method according to any preceding Supplementary Note, wherein the NCR support indication is received from the access network node in system information block, SIB, information transmitted by the access network node.

### (Supplementary Note 6)

The method according to Supplementary Note 5, wherein:
the NCR support indication is received from the access network node in SIB1; and
wherein when multiple public land mobile network, PLMN, are indicated in SIB, the NCR support indication is common to all of the indicated PLMN.

### (Supplementary Note 7)

A method performed by a network controlled repeater, NCR, the method comprising:
transmitting, to an access network node, forwarding capability information indicating a forwarding capability of the NCR.

### (Supplementary Note 8)

The method according to Supplementary Note 7, wherein the forwarding capability information indicates a number of syncronisation signal blocks, SSBs, supported by the NCR.

### (Supplementary Note 9)

The method according to Supplementary Note 7 or 8, wherein the method further comprises:
receiving, from the access network node, forwarding control information for controlling forwarding by the NCR.

### (Supplementary Note 10)

The method according to Supplementary Note 9, wherein the forwarding control information is received from the access network node in RRC signalling.

### (Supplementary Note 11)

The method according to Supplementary Note 10, wherein the forwarding control information is received from the access network node in an RRC reconfiguration message.

### (Supplementary Note 12)

The method according to any one of Supplementary Notes 7 to 9, wherein the forwarding control information is received from the access network node in an NCR setup message.

### (Supplementary Note 13)

The method according to Supplementary Note 12, wherein the method further comprises:

transmitting, to the access network node, an NCR setup complete message after receiving the NCR setup message; and

activating forwarding between the NCR and a user equipment, UE, based on the forwarding control information received from the access network node.

### (Supplementary Note 14)

The method according to any one of Supplementary Notes 9 to 13, wherein the forwarding control information comprises at least one of:
a set of syncronisation signal blocks, SSBs, for use by the NCR to forward signals;
timing information indicating a time at which the NCR is to forward a signal between the access network node and a user equipment, UE;
frequency information indicating a frequency to be used for communication on an access link between the NCR and a UE, or a frequency to be used for communication between the NCR and the access network node; and
beam information indicating a beam direction to be used for a transmission or reception between the NCR and the UE, or for a transmission between the NCR and the access network node.

### (Supplementary Note 15)

The method according to any one of Supplementary Notes 9 to 14, wherein the method further comprises:
receiving further forwarding control information from the access network node; and
controlling forwarding between the NCR and a user equipment, UE, based on the further forwarding control information.

### (Supplementary Note 16)

The method according to Supplementary Note 15, wherein the further forwarding control information is received from the access network node in a medium access control control-element, MAC CE.

### (Supplementary Note 17)

A method performed by an access network node, the method comprising:
transmitting, to a network controlled repeater, NCR, an NCR support indication that indicates whether a function of an NCR is supported by the access network node; and
receiving, from the NCR, in a case where the NCR support indication indicates that the function of the NCR is supported by the access network node, an NCR device indication that indicates that the NCR is an NCR device.

### (Supplementary Note 18)

The method according to Supplementary Note 17, further comprising:
receiving, from the NCR, when the NCR support indication indicates that the function of the NCR is supported by the access network node, a request to set up a radio resource control, RRC, connection;
transmitting, to the NCR, a response to the request to set up the RRC connection; and
receiving an RRC message from the NCR, wherein the RRC message includes the NCR device indication.

### (Supplementary Note 19)

The method according to Supplementary Note 18, further comprising transmitting, to a core network node for mobility management, after the access network node has received the RRC message from the NCR, and INITIAL UE MESSAGE comprising the NCR device indication.

### (Supplementary Note 20)

The method according to Supplementary Note 17, further comprising:
receiving, from the NCR, an indication corresponding to radio capability information of the NCR;
wherein the indication corresponding the radio capability information of the NCR includes the NCR device indication.

### (Supplementary Note 21)

The method according to any one of Supplementary Notes 17 to 20, wherein transmitting the NCR support indication comprises transmitting system information that includes the NCR support indication.

### (Supplementary Note 22)

The method according to any one of Supplementary Notes 17 to 21, wherein transmitting the NCR support indication comprises transmitting system information block, SIB, information that includes the NCR support indication.

### (Supplementary Note 23)

A method performed by an access network node, the method comprising:
receiving, from a network controlled repeater, NCR, forwarding capability information indicating a forwarding capability of the NCR.

### (Supplementary Note 24)

The method according to Supplementary Note 23, wherein the forwarding capability information indicates a number of syncronisation signal blocks, SSBs, supported by the NCR.

### (Supplementary Note 25)

The method according to Supplementary Note 23 or 24, wherein the method further comprises:
transmitting, to the NCR, after receiving the forwarding capability information, forwarding control information for controlling forwarding by the NCR.

### (Supplementary Note 26)

The method according to Supplementary Note 25, wherein transmitting the forwarding control information comprises transmitting RRC signalling including the forwarding control information.

### (Supplementary Note 27)

The method according to Supplementary Note 26, wherein transmitting the forwarding control information comprises transmitting the forwarding control information in an RRC reconfiguration message.

### (Supplementary Note 28)

The method according to any one of Supplementary Notes 23 to 25, wherein the transmitting the forwarding control information comprises transmitting the forwarding control information in an NCR setup message.

### (Supplementary Note 29)

The method according to Supplementary Note 28, further comprising:
receiving, from the NCR, an NCR setup complete message after transmitting the NCR setup message.

### (Supplementary Note 30)

The method according to any one of Supplementary Notes 25 to 29, wherein the forwarding control information comprises at least one of:
a set of syncronisation signal blocks, SSBs, for use by the NCR to forward signals;
timing information indicating a time at which the NCR is to forward a signal between the access network node and a user equipment, UE;
frequency information indicating a frequency to be used for communication on an access link between the NCR and a UE, or a frequency to be used for communication between the NCR and the access network node; and
beam information indicating a beam direction to be used for a transmission between the NCR and the UE, or for a transmission between the NCR and the access network node.

### (Supplementary Note 31)

The method according to any one of Supplementary Notes 25 to 30, further comprising:
transmitting further forwarding control information to the NCR;
wherein the further forwarding control information is for control, by the NCR, of forwarding between the NCR and a user equipment.

### (Supplementary Note 32)

A network controlled repeater, NCR, comprising:
means for receiving, from an access network node, an NCR support indication that indicates whether a function of the NCR is supported by the access network node; and
means for transmitting, to the access network node, in a case where the NCR support indication indicates that the function of the NCR is supported by the access network node, an NCR device indication that indicates that the NCR is an NCR device.

### (Supplementary Note 33)

A network controlled repeater, NCR, comprising:
means for transmitting, to an access network node, forwarding capability information indicating a forwarding capability of the NCR.

### (Supplementary Note 34)

An access network node comprising:
means for transmitting, to a network controlled repeater, NCR, an NCR support indication that indicates whether a function of an NCR is supported by the access network node; and
means for receiving, from the NCR, in a case where the NCR support indication indicates that the function of the NCR is supported by the access network node, an NCR device indication that indicates that the NCR is an NCR device.

### (Supplementary Note 35)

An access network node comprising:
means for receiving, from a network controlled repeater, NCR, forwarding capability information indicating a forwarding capability of the NCR.

This application is based upon and claims the benefit of priority from Great Britain Patent Application No. 2211653.7, filed on Aug. 9, 2022, the disclosure of which is incorporated herein in its entirety by reference.

### REFERENCE SIGNS LIST

1 mobile (cellular or wireless) telecommunication system
3 mobile device
5 base station
6 cell
7 core network
8-1 Access and Mobility Management Function (AMF)
8-2 control plane function (CPF)
8-3 user plane function (UPF)
8-4 Session Management Function (SMF)
8-5 Operations, Administration and Maintenance (OAM) function
9 network controlled repeater (NCR)
10 data network
21 transceiver circuit
22 antenna
23 controller
24 user interface
25 memory
26 operating system
27 communications control module
31 transceiver circuit
32 antenna
33 controller
34 memory
35 operating system
36 communications control module
37 control link module
38 amplification and forwarding module
41 transceiver circuit
42 antenna
43 network interface
44 controller
45 memory
46 operating system
47 communications control module
48 control link module
49 backhaul module
201 NCR-MT
202 NCR-Fwd

What is claimed is:

1. A method performed by a network controlled repeater (NCR), the method comprising:
receiving, from an access network node, support information indicating whether a function of the NCR is supported by the access network node;
transmitting, to the access network node, a device indication indicating that the NCR is an NCR device; and
receiving, from the access network node, a Radio Resource Control (RRC) message including configuration information for forwarding data from the access network node via an access link between the NCR and at least one user equipment (UE),
wherein the configuration information includes information indicating a respective combination of timing information and beam-related information per resource in resource sets for the forwarding.

2. (canceled)

3. The method according to claim 1, further comprising:
ignoring, configuration of cellBarred, cellReservedForOperatorUse, cellReservedForOtherUse, and Unified Access Control, which are provided by the access network node.

4.-8. (canceled)

9. The method according to claim 1, wherein:
the support information is included in a system information block 1 (SIB1); and
in a case where information of multiple public land mobile networks (PLMNs), are indicated in the SIB1, the support information is common to all of the PLMNs.

10.-15. (canceled)

16. The method according to claim 1, further comprising:
activating forwarding between the NCR and the at least one UE, based on the configuration information.

17. (canceled)

18. The method according to claim 1, further comprising:
receiving, from the access network node, control information in a medium access control control-element (MAC CE); and
controlling the forwarding based on the control information.

19. The method according to claim 18, wherein
the control information includes at least one of:
an index for updating configuration of at least one beam to be used for the forwarding, and
beam information indicating the at least one beam.

20. The method according to claim 1, wherein
the timing information indicates at least one of:
a time window,
a periodicity which a respective time window repeats, or
a bitmap to indicate timing pattern.

21. A method performed by an access network node, the method comprising:
transmitting, to a network controlled repeater (NCR), support information indicating whether a function of the NCR is supported by the access network node;
receiving, from the NCR, a device indication that indicates that the NCR is an NCR device; and
transmitting, to the NCR, a Radio Resource Control (RRC) message including configuration information for forwarding, by the NCR, data from the access network node via an access link between the NCR and at least one user equipment (UE),
wherein the configuration information includes information indicating a respective combination of timing information and beam-related information per resource in resource sets for the forwarding.

22. A network controlled repeater (NCR), comprising:
at least one memory storing instructions; and
at least one processor configured to process the instructions to:
receive, from an access network node, support information indicating whether a function of the NCR is supported by the access network node;
transmit, to the access network node, a device indication that indicates that the NCR is an NCR device; and
receive, from the access network node, a Radio Resource Control (RRC) message including configuration information for forwarding data from the access network node via an access link between the NCR and at least one user equipment (UE),
wherein the configuration information includes information indicating a respective combination of timing information and beam-related information per resource in resource sets for the forwarding.

23. An access network node comprising:
at least one memory storing instructions; and
at least one processor configured to process the instructions to:
transmit, to a network controlled repeater (NCR), support information indicating whether a function of the NCR is supported by the access network node;
receive, from the NCR, a device indication that indicates that the NCR is an NCR device; and
transmit, to the NCR, a Radio Resource Control (RRC) message including configuration information for forwarding, by the NCR, data from the access network node via an access link between the NCR and at least one user equipment (UE),
wherein the configuration information includes information indicating a respective combination of timing information and beam-related information per resource in resource sets for the forwarding.

24. The method according to claim 1, wherein
the configuration information is related to semi-persistent resources or periodic resources.
